(19) United States
(12) Patent Application Publication
(10) Pub. No.: US 2026/0017611 A1
(43) Pub. Date: Jan. 15, 2026

(54) SYSTEMS AND METHODS FOR IDENTIFYING ENTITIES OF INTEREST

(71) Applicant: JPMORGAN CHASE BANK, N.A., New York, NY (US)

(72) Inventors: Harshavardhan Reddy MUKKERA, Sugar Land, TX (US); Bret GOLDSMITH, Sugar Land, TX (US); Joel Alan POTTS, London (GB); Hirenkumar PATEL, Sugar Land, TX (US); Rohit AGRAWAL, Jersey City, NJ (US); Manoj MANOHARAN, Rye, NY (US)

(21) Appl. No.: 18/661,111

(22) Filed: May 10, 2024

Related U.S. Application Data
(63) Continuation-in-part of application No. 17/455,535, filed on Nov. 18, 2021, now abandoned.

(51) Int. Cl. G06Q 10/10

(52) U.S. Cl. CPC G06Q 10/10

(57) ABSTRACT

A method may include: (1) receiving, by an entity identification computer program executed by a backend and from a requestor via a requestor electronic device, transaction information and an entity search term for a desired entity; (2) receiving, by the entity identification computer program, requestor information for the requestor; (3) receiving, by the entity identification computer program, entity preferences for an organization or for the requestor; (4) applying, by the entity identification computer program, a multi-level search algorithm to identify a target entity using the transaction information, the entity search term, the requestor information, and the entity preferences; (5) receiving, by the entity identification computer program, an indication that the target entity is the desired target entity; (6) retrieving, by the entity identification computer program, contact information for the target entity; and (7) returning, by the entity identification computer program, the contact information to the requestor.

### RELATED APPLICATIONS

This application claims priority to, and the benefit of, U.S. patent application Ser. No. 17/455,535, filed Nov. 18, 2021, the disclosure of which is hereby incorporated, by reference, in its entirety.

### BACKGROUND OF THE INVENTION

### 1. Field of the Invention

Embodiments relate generally to systems and methods for identifying entities of interest.

### 2. Description of the Related Art

Business entities often have complex structures, and the purpose of that structure may not be readily apparent to an outsider. For example, one subsidiary of an entity may be responsible for entering into legal contracts; another may be responsible for investments; still another may be responsible for real estate management. Thus, when seeking to engage the proper subsidiary, it is difficult for an outsider to know where to start.

### SUMMARY OF THE INVENTION

Systems and methods for identifying entities of interest are disclosed. In one embodiment, a method may include: (1) receiving, by an entity identification computer program executed by a backend and from a requestor via a requestor electronic device, transaction information and an entity search term for a desired entity; (2) receiving, by the entity identification computer program, requestor information for the requestor; (3) receiving, by the entity identification computer program, entity preferences for an organization or for the requestor; (4) applying, by the entity identification computer program, a multi-level search algorithm to identify a target entity using the transaction information, the entity search term, the requestor information, and the entity preferences; (5) receiving, by the entity identification computer program, an indication that the target entity is the desired target entity; (6) retrieving, by the entity identification computer program, contact information for the target entity; and (7) returning, by the entity identification computer program, the contact information to the requestor.

In one embodiment, the product information comprises an identification of product to present to the desired entity.

In one embodiment, the entity search term may include at least part of an entity name for the desired entity.

In one embodiment, the requestor information may include a job position for the requestor, a job responsibility for the requestor, and a past product offered by the requestor.

In one embodiment, the method may also include: receiving, by the entity identification computer program, historical entity interaction data for a plurality of entities, wherein the historical entity interaction data may include past engagements with the plurality of entities and past products offered to the entities.

In one embodiment, a first level of the multi-level search algorithm identifies potential target entities from preferred clients that have names that begin with the entity search term, a second level of the multi-level search algorithm adds potential target entities from preferred clients that have names that include the entity search term, a third level of the multi-level search algorithm adds potential target entities from local subsidiaries of preferred clients that have names that begin with the entity search term, and a fourth level of the multi-level search algorithm adds potential target entities from local subsidiaries of preferred clients that have names that includes the entity search term.

In one embodiment, the method may also include: identifying, by the computer program, an individual in the organization having a conflict of interest with the target entity; and restricting, by the computer program, the individual from accessing information related to the target entity.

In one embodiment, the method may also include: pre-populating, by the computer program, transaction details with public and/or private information for the target entity.

In one embodiment, the method may also include: suggesting, by the computer program, individuals to work on a transaction involving the target entity based on the identification of the target entity.

According to another embodiment, a non-transitory computer readable storage medium, may include instructions stored thereon, which when read and executed by one or more computer processors, cause the one or more computer processors to perform steps comprising: receiving, from a requestor electronic device, transaction information and an entity search term for a desired entity; receiving requestor information for the requestor; receiving entity preferences for an organization or for the requestor; applying a multi-level search algorithm to identify a target entity using the transaction information, the entity search term, the requestor information, and the entity preferences; receiving an indication that the target entity is the desired target entity; retrieving contact information for the target entity; and returning the contact information to the requestor.

In one embodiment, the product information may include an identification of product to present to the desired entity.

In one embodiment, the entity search term may include at least part of an entity name for the desired entity.

In one embodiment, the requestor information may include a job position for the requestor, a job responsibility for the requestor, and a past product offered by the requestor.

In one embodiment, the computer readable storage medium may also include instructions stored thereon, which when read and executed by the one or more computer processors, cause the one or more computer processors to perform steps comprising: receiving historical entity interaction data for a plurality of entities, wherein the historical entity interaction data may include past engagements with the plurality of entities and past products offered to the entities.

In one embodiment, a first level of the multi-level search algorithm identifies potential target entities from preferred clients that have names that begin with the entity search term, a second level of the multi-level search algorithm adds potential target entities from preferred clients that have names that include the entity search term, a third level of the multi-level search algorithm adds potential target entities from local subsidiaries of preferred clients that have names that begin with the entity search term, and a fourth level of the multi-level search algorithm adds potential target entities from local subsidiaries of preferred clients that have names that includes the entity search term.

In one embodiment, the computer readable storage medium may also include instructions stored thereon, which when read and executed by the one or more computer processors, cause the one or more computer processors to perform steps comprising: identifying an individual in the organization having a conflict of interest with the target entity; and restricting the individual from accessing information related to the target entity.

In one embodiment, the computer readable storage medium may also include instructions stored thereon, which when read and executed by the one or more computer processors, cause the one or more computer processors to perform steps comprising: pre-populating transaction details with public and/or private information for the target entity.

In one embodiment, the computer readable storage medium may also include instructions stored thereon, which when read and executed by the one or more computer processors, cause the one or more computer processors to perform steps comprising: suggesting individuals to work on a transaction involving the target entity based on the identification of the target entity.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for identifying entities of interest according to an embodiment;

FIG. 2 depicts a method for identifying entities of interest according to an embodiment;

FIG. 3 depicts an exemplary search algorithm according to an embodiment; and

FIG. 4 depicts an exemplary computing system for implementing aspects of the present disclosure.

### DETAILED DESCRIPTION OF PREFERRED EMBODIMENTS

Embodiments relate generally to systems and methods for identifying entities of interest.

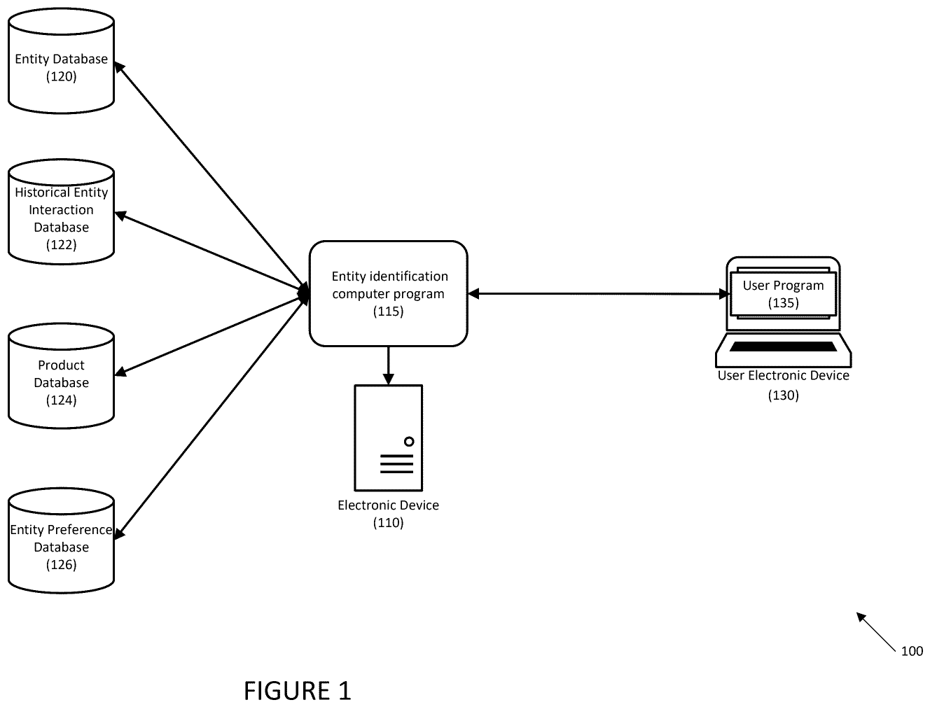

Referring to FIG. 1, a system for identifying entities of interest is disclosed according to an embodiment. System 100 may include electronic device 110 that may be any suitable electronic device, including servers (physical and/or cloud based), computer (e.g., workstations, desktops, notebooks, tablets, etc.), smart devices, Internet of Things (IoT) appliances, etc.

Electronic device 110 may execute entity identification computer program 115, which may interface with a plurality of databases, including for example entity database 120, historical entity interaction database 122, product database 124, and entity preference database 126. Entity identification computer program 115 may also interface with user computer program 135 that may be executed by user electronic device 130. User electronic device 130 may be any suitable electronic device, including computers, smart devices, IoT appliances, terminals, kiosks, etc.

Entity database 120 may store data regarding a plurality of entities, including, for example, each entity's legal structure, affiliates, subsidiaries, legal responsibilities, country of access, the location, industry classification, a company identifier, whether the entity is publicly traded or is private, a client priority status (e.g., prospect or existing client), etc.

Historical entity interaction database 122 may store data regarding past interactions with entities, including the type of work that each entity is involved in, past contracts that each entity has, past responsibilities of each entity, etc.

Product database 124 may store data regarding product, such as a financial product, that may be available to offer to an entity.

Entity preference database may store an organization's or an individual's preferences for using an entity. The preferences may be based on prior interactions, relationships, location, types of transactions supported, etc.

Additional data, such as location-activity data (e.g., to identify a density of where there is the most activity, where a new business is being built, etc.), industry movements, business landscapes, external news and insights, etc. may be provided in additional database(s) (not shown) as is necessary and/or desired.

Entity identification computer program 115 may receive an entity search term, such as a keyword, and may apply an interactive entity search algorithm to identify a target entity to engage.

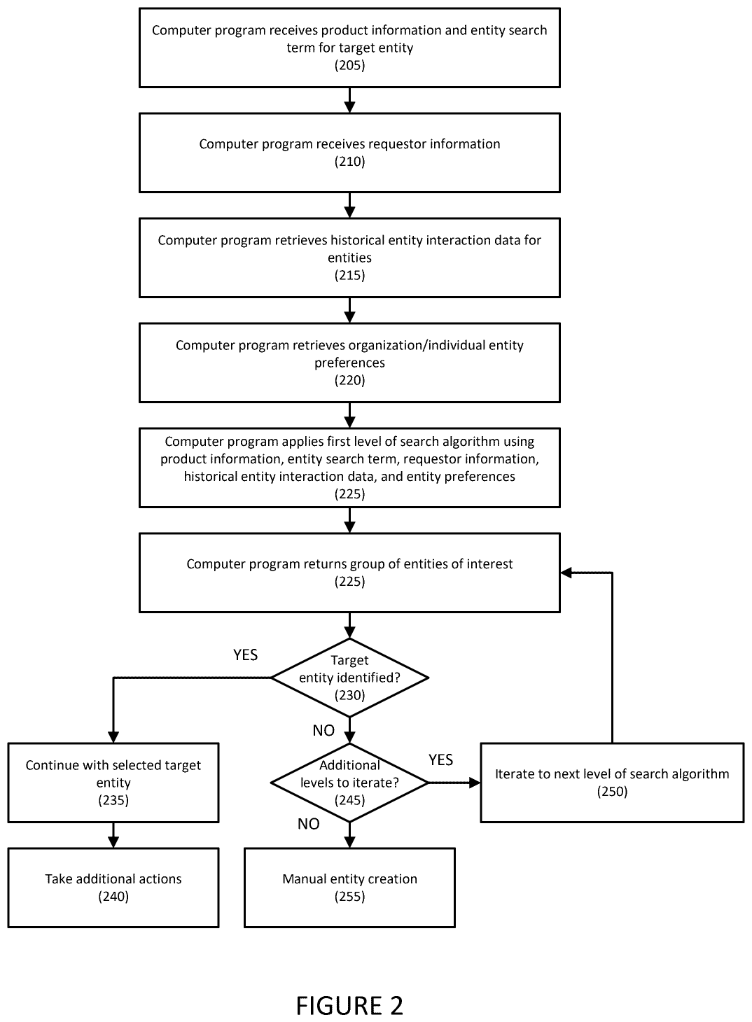

FIG. 2 depicts a method for identifying entities of interest according to an embodiment.

In step 205, a computer program, such as an entity identification computer program, may receive product information and an entity search term from a user. For example, the product may be a financial product to offer to the entity, a legal contract to present to the entity for review and execution, etc.

The entity search term may include a term, such as an entity name, a partial entity name, etc. for a target entity.

In one embodiment, the entity identification computer program may present a user interface that includes prompts for facilitating entry of information by a user.

In step 210, the computer program may receive information about the requestor, such as the requestor's position, job responsibilities, past products, contracts, etc. For example, some requestors may be qualified to sell, some may be allowed to sell (e.g., have a Financial Industry Regulatory Authority (“FINRA”) registration or similar, etc. The computer program may consider the information and may determine a likelihood of being able to complete a sale. Because the likelihood is based on dynamic information, the output may also be dynamic.

In step 215, the computer program may retrieve historical entity interaction data for a plurality of entities. In one embodiment, the historical entity interaction data may identify past engagements with the entity, including products offered, contracts entered into, etc.

In step 220, the computer program may receive organizational or individual entity preferences. In one embodiment, the entity preference may identify entities that are preferred to be selected, entities that are neutral, and entities that are discouraged from being selected. The entity preferences may also provide a selection hierarchy of entities in a certain field. The entity preferences may vary based on individual, location, type of transaction, etc.

In step 225, the computer program may apply a first level of a search algorithm to entities in the entity database to identify a target entity. For example, the search algorithm may be structured so that in an initial pass, a relatively narrow pool of potential target entities may be identified, and in subsequent passes, the qualified pool of potential target entities may be progressively broadened until the target entity, or a desired number of offerees, has been identified.

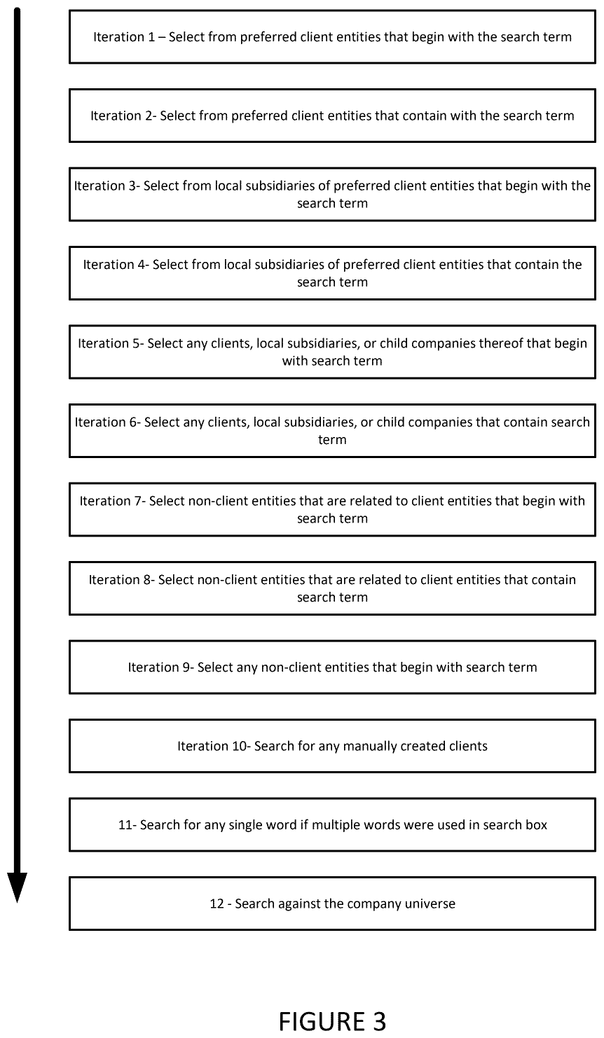

For example, FIG. 3 depicts an example of the search algorithm according to one embodiment. The search algorithm may include several search levels by which the pool of potential target entities is progressively broadened. In a first iteration, the search algorithm may search for and identify client entities in the database that have at least one information item that begins with the exact search term. For example, if the search term is “ABC Company,” all entities in the database that begin with the exact phrase “ABC Company” are returned. As another example, if the search term is “123 Main Street,” all entities in the database having addresses that begin with the exact phrase “123 Main Street” are returned.

In one embodiment, the entities reviewed in the first search iteration may be limited to client entities in the database that are preferred to use based on the entity preferences, the type of transaction, and/or the historical interactions with the entities.

In a second iteration, the computer program may broaden the pool by searching for client entities in the database that have at least one information item including the entity search term. For example, using the “ABC Company” example, the second iteration would also return “Northern ABC Company.”

In one embodiment, the entities reviewed in the second search iteration may also be limited to client entities in the database that are preferred to use based on the entity preferences, the type of transaction, and/or the historical interactions with the entities.

In a third iteration, the computer program may broaden the pool by searching for local subsidiaries of the client entities identified in the first iteration that have at least one information item that begins with the exact search term.

In a fourth iteration, the computer program may search the client entities identified in the third iteration that have at least one information item that contains the search term.

In a fifth iteration, the computer program may broaden the pool by searching for child companies/entities of the client entities identified in the first iteration that includes at least one information item that begins with the exact search term.

In a sixth iteration, the computer program may search the client entities identified in the fifth iteration that have at least one information item that contains the search term.

In a seventh iteration, the computer program may broaden the pool by searching for non-client entities that are related to client entities that have at least one information item that begins with the exact search term.

In an eight iteration, the computer program may search the non-client entities identified in the seventh iteration that have at least one information item that contains the search term.

In a ninth iteration, the computer program may broaden the pool by searching for any non-client entities that have at least one information item that begins with the exact search term.

In a tenth iteration, the computer program may broaden the pool by searching for all manually created clients.

In an eleventh iteration, the search term may be revised so that only a single word from a multi-word search term is used.

In a twelfth iteration, the search may be expanded to the complete universe of any entities associated with the company.

Referring again to FIG. 2, in step 225, the computer program may output the results of the search algorithm. In one embodiment, the results may include a list of potential target entities. In one embodiment, links to additional information for each potential target entity, including the reason why it was identified as a potential target entity, may be provided.

In one embodiment, if the search algorithm does not identify any additional potential target entities at the search level, it may automatically iterate to the next level of the search algorithm without outputting search results.

In step 230, the computer program may receive an indication from the user as to whether one of the potential target entities is the desired target entity. If it is, in step 235, the computer program may stop iterating and may return contact information for the target entity.

In step 240, once the target entity is identified, the computer program may take one or more additional actions. For example, the computer program may automatically pre-populate facets of a transaction using known private and public information known around the target entity. The computer program may use the identification of the target entity to identify conflicts of interest (e.g., confidentiality issues with certain individuals) to suggest potential team members to work on a transaction involving the target entity. In another embodiment, the computer program may restrict a conflicted individual from accessing any electronic information based on the identification of the target.

In another embodiment, the computer program may select potential counterparty roles on the transaction based on the selected party having known business preferences. For example, for a certain type of transaction, the target entity may only have possible candidates for the transaction.

If one of the potential target entities is not the desired target entity, then in step 245, a check may be made to see if there are additional search levels in the search algorithm to iterate through. If there are, in step 250, the computer program may iterate through the next level of the search algorithm and return to step 225.

If there are no additional levels in the search algorithm, in step 255, the computer program may receive information for the target entity and manually create the entity.

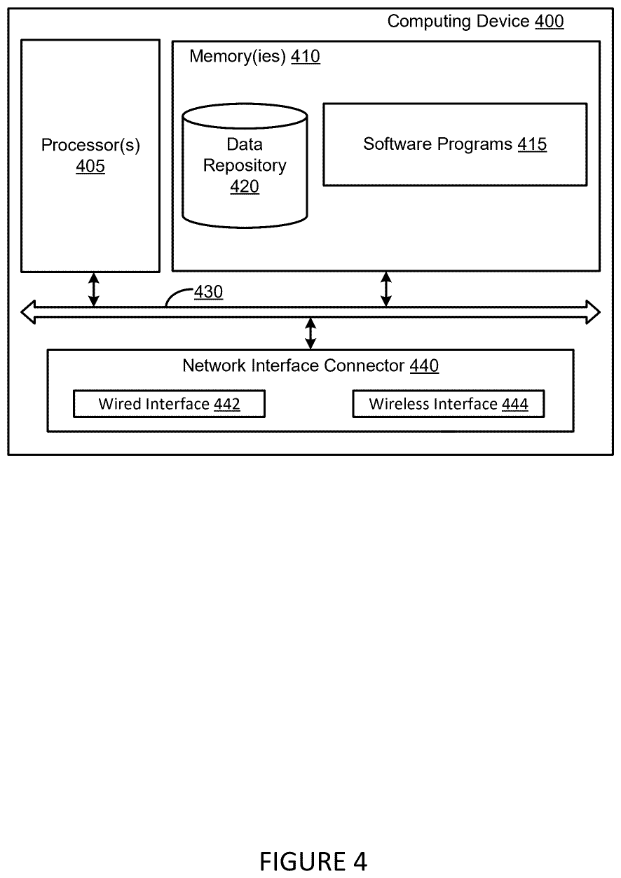

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be non-volatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Although multiple embodiments have been described, it should be recognized that these embodiments are not exclusive to each other, and that features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for identifying entities of interest, comprising:
receiving, by an entity identification computer program executed by a backend and from a requestor via a requestor electronic device, transaction information and an entity search term for a desired entity;
receiving, by the entity identification computer program, requestor information for the requestor;
receiving, by the entity identification computer program, entity preferences for an organization or for the requestor;
applying, by the entity identification computer program, a multi-level search algorithm to identify a target entity using the transaction information, the entity search term, the requestor information, and the entity preferences;
receiving, by the entity identification computer program, an indication that the target entity is the desired target entity;
retrieving, by the entity identification computer program, contact information for the target entity; and
returning, by the entity identification computer program, the contact information to the requestor.

2. The method of claim 1, wherein the product information comprises an identification of product to present to the desired entity.

3. The method of claim 1, wherein the entity search term comprises at least part of an entity name for the desired entity.

4. The method of claim 1, wherein the requestor information comprises a job position for the requestor, a job responsibility for the requestor, and a past product offered by the requestor.

5. The method of claim 1, further comprising:
receiving, by the entity identification computer program, historical entity interaction data for a plurality of entities, wherein the historical entity interaction data comprises past engagements with the plurality of entities and past products offered to the entities.

6. The method of claim 1, wherein a first level of the multi-level search algorithm identifies potential target entities from preferred clients that have names that begin with the entity search term, a second level of the multi-level search algorithm adds potential target entities from preferred clients that have names that include the entity search term, a third level of the multi-level search algorithm adds potential target entities from local subsidiaries of preferred clients that have names that begin with the entity search term, and a fourth level of the multi-level search algorithm adds potential target entities from local subsidiaries of preferred clients that have names that includes the entity search term.

7. The method of claim 1, further comprising:
identifying, by the computer program, an individual in the organization having a conflict of interest with the target entity; and
restricting, by the computer program, the individual from accessing information related to the target entity.

8. The method of claim 1, further comprising:
pre-populating, by the computer program, transaction details with public and/or private information for the target entity.

9. The method of claim 1, further comprising:
suggesting, by the computer program, individuals to work on a transaction involving the target entity based on the identification of the target entity.

10. A non-transitory computer readable storage medium, including instructions stored thereon, which when read and executed by one or more computer processors, cause the one or more computer processors to perform steps comprising:
receiving, from a requestor electronic device, transaction information and an entity search term for a desired entity;
receiving requestor information for the requestor;
receiving entity preferences for an organization or for the requestor;
applying a multi-level search algorithm to identify a target entity using the transaction information, the entity search term, the requestor information, and the entity preferences;
receiving an indication that the target entity is the desired target entity;
retrieving contact information for the target entity; and
returning the contact information to the requestor.

11. The non-transitory computer readable storage medium of claim 10, wherein the product information comprises an identification of product to present to the desired entity.

12. The non-transitory computer readable storage medium of claim 10, wherein the entity search term comprises at least part of an entity name for the desired entity.

13. The non-transitory computer readable storage medium of claim 10, wherein the requestor information comprises a job position for the requestor, a job responsibility for the requestor, and a past product offered by the requestor.

14. The non-transitory computer readable storage medium of claim 10, further including instructions stored thereon, which when read and executed by the one or more computer processors, cause the one or more computer processors to perform steps comprising:
receiving historical entity interaction data for a plurality of entities, wherein the historical entity interaction data comprises past engagements with the plurality of entities and past products offered to the entities.

15. The non-transitory computer readable storage medium of claim 10, wherein a first level of the multi-level search algorithm identifies potential target entities from preferred clients that have names that begin with the entity search term, a second level of the multi-level search algorithm adds potential target entities from preferred clients that have names that include the entity search term, a third level of the multi-level search algorithm adds potential target entities from local subsidiaries of preferred clients that have names that begin with the entity search term, and a fourth level of the multi-level search algorithm adds potential target entities from local subsidiaries of preferred clients that have names that includes the entity search term.

16. The non-transitory computer readable storage medium of claim 10, further including instructions stored thereon, which when read and executed by the one or more computer processors, cause the one or more computer processors to perform steps comprising:
identifying an individual in the organization having a conflict of interest with the target entity; and
restricting the individual from accessing information related to the target entity.

17. The non-transitory computer readable storage medium of claim 10, further including instructions stored thereon, which when read and executed by the one or more computer processors, cause the one or more computer processors to perform steps comprising:
pre-populating transaction details with public and/or private information for the target entity.

18. The non-transitory computer readable storage medium of claim 10, further including instructions stored thereon, which when read and executed by the one or more computer processors, cause the one or more computer processors to perform steps comprising:
suggesting individuals to work on a transaction involving the target entity based on the identification of the target entity.
